(19) United States
(12) Patent Application Publication
(10) Pub. No.: US 2004/0137891 A1
(43) Pub. Date: Jul. 15, 2004

(54) Application packaging and branding in a feature/service/solution client-service delivery environment

(76) Inventors: Matt Clark, Carnation, WA (US); Shane Meyer, Redmond, WA (US); Chris Romanzin, Seattle, WA (US); Brian C. Roundtree, Kirkland, WA (US)

Correspondence Address: SCHWABE, WILLIAMSON & WYATT, P.C., PACWEST CENTER, SUITES 1600-1900, 1211 SW FIFTH AVENUE, PORTLAND, OR, 97204, US

(21) Appl. No.: 10/705,764

(22) Filed: Nov. 10, 2003

Related U.S. Application Data
(60) Provisional application No. 60/425,165, filed on Nov. 8, 2002.
(60) Provisional application No. 60/424,832, filed on Nov. 8, 2002.
(60) Provisional application No. 60/424,905, filed on Nov. 8, 2002.
(60) Provisional application No. 60/424,906, filed on Nov. 8, 2002.
(60) Provisional application No. 60/424,910, filed on Nov. 8, 2002.

(51) Int. Cl. H04M 3/00

(52) U.S. Cl. 455/418

(57) ABSTRACT

A method, computer readable medium and apparatus are provided for branding of user interfaces on wireless mobile devices. Feature-specific user interface branding components being provided by a remote server.

### CROSS-REFERENCE TO RELATED APPLICATIONS

This application claims the benefit of U.S. Provisional Application No. 60/425,165, filed on Nov. 8, 2002, entitled VENDOR APPLICATION PROGRAMMING INTERFACE OF A SERVICE PROVIDER APPLICATION FOR CLIENT-SERVER BASED SERVICE DELIVERY; U.S. Provisional Application No. 60/424,832, filed on Nov. 8, 2002, entitled SERVICE-VENDOR REQUEST PROCESSING FOR CLIENT-SERVER SERVICE DELIVERY; U.S. Provisional Application No. 60/424,905, filed on Nov. 8, 2002, entitled APPLICATION PACKAGING AND BRANDING IN A FEATURE/SERVICE/SOLUTION CLIENT-SERVER DELIVERY ENVIRONMENT; U.S. Provisional Application No. 60/424,906, filed on Nov. 8, 2002, entitled FEATURE-BASED SOLUTION PROVISIONING FOR CLIENT-SERVER DATA SERVICES; and U.S. Provisional Application No. 60,424,910, filed on Nov. 8, 2002, entitled FEATURE/CONCEPT BASED LOCAL REQUEST FORMATION FOR CLIENT-SERVER DATA SERVICES, the specifications and drawings of which are incorporated herein in full by reference. Also incorporated by reference in its entirety is cofiled U.S. patent application Ser. No. 10/705,456, entitled PROGRAMMING INTERFACE LAYER OF A SERVICE PROVIDER FOR DATA SERVICE DELIVERY with the following Inventors: Brian C. Roundtree, Matt Clark, Shane Meyer and Chris Romanzin, filed on Nov. 10, 2003.

### FIELD OF THE INVENTION

The present invention relates to the fields of data processing and wireless communications. More specifically, the present invention relates to request formulation on a client device for consumption of server-based data services, having particular application to data service consumption using wireless mobile communication devices.

### BACKGROUND OF THE INVENTION

Historically, client-server based service delivery has often been server centric, that is, with the servers performing the bulk of the processing, and the clients being tightly coupled and/or persistently connected to the servers. This is especially true in the case of the “thin” clients.

With advances in microprocessor and related technologies, the processing power of client devices, including wireless client devices such as wireless mobile phones and personal data assistants (“PDAs”), has increased significantly. While, increasingly, more processing is being distributed onto the client devices, e.g. through the use of distributed applets, client-server based service delivery, especially browser/web based service delivery, continues to require tight coupling and/or substantially persistent connections between the client devices and the servers.

With the advance of the Internet, World Wide Web (“WWW”), and most recently a new generation of wireless “telephony” network, the potential for delivery of a wide range of services to users of client devices continues to expand.

However, accessing services through the WWW, in particular, through wireless mobile devices, such as wireless mobile phones, has proved to be cumbersome and undesirable.

A number of “integration” technologies are emerging to enable different web-based services to be more easily integrated and presented as a “single” application. However, the approach is “integrator” centric. Further, the approach continues to require substantially persistent connections between the client devices and the servers, which is undesirable for wireless mobile devices consuming data services through the wireless telephony network, as the consumption of network resources, such as “air time” is costly.

### BRIEF DESCRIPTION OF DRAWINGS

The present invention will be described by way of exemplary embodiments, but not limitations, illustrated in the accompanying drawings in which like references denotes similar elements, and in which:

FIG. 1 is a pictorial diagram of a number of devices connected to a network which provide a client device also connected to the network with data services in accordance with embodiments of the present invention.

FIG. 2 is a block diagram of a client device that provides an exemplary operating environment for an embodiment of the present invention.

FIG. 3 is a block diagram of a framework server that provides an exemplary operating environment for an embodiment of the present invention.

FIG. 4 is a diagram illustrating the actions taken by devices in a framework system to provide data services in response to feature/concept based requests in accordance with embodiments of the present invention.

FIG. 5 is a flow diagram illustrating a concept gathering subroutine in accordance with embodiments of the present invention.

FIG. 6 is a flow diagram illustrating a solution rendering subroutine in accordance with embodiments of the present invention.

FIG. 7 is a flow diagram illustrating a request handling subroutine in accordance with embodiments of the present invention.

FIG. 8 is a flow diagram illustrating a solution processing subroutine in accordance with embodiments of the present invention.

FIG. 9 is a flow diagram illustrating a result handling subroutine in accordance with embodiments of the present invention.

FIG. 10 is a diagram illustrating the actions taken by devices in a framework system to provide data services in response to solution commands in accordance with embodiments of the present invention.

FIGS. 11a-d are exemplary screen shots of concept gathering displays in accordance with embodiments of the present invention.

FIG. 12 is a diagram of an exemplary feature tree in accordance with embodiments of the present invention.

FIGS. 13a-c illustrate exemplary solution data structures in accordance with embodiments of the present invention.

FIG. 14 is a diagram illustrating the actions taken by devices in a framework system to provide supplemental information in accordance with embodiments of the present invention.

FIG. 15 is an exemplary screen shot of a branded display in accordance with embodiments of the present invention.

### DETAILED DESCRIPTION OF EMBODIMENTS OF THE INVENTION

The detailed description which follows is represented largely in terms of processes and symbolic representations of operations by conventional computing components, including processors, memory storage devices for the processors, connected display devices and input devices, all of which are well-known in the art. These processes and operations may utilize conventional computing components in a heterogeneous distributed computing environment, including remote storage servers, computer servers, and memory storage devices, such processes, devices, servers and operations also being known to those skilled in the art and others. Each of these conventional distributed computing components may be accessible by the processors and devices via a communications network.

Embodiments of the present invention include feature/concept based request formations on a client device for the consumption of data services, having special application to the consumption of data services using a wireless mobile device. Such embodiments of the present invention may include installing features and complementary logic on a client device. Each feature may include a “feature tree” of associated “concept leaves”; and the complementary logic allows a user to locally formulate a request for any one of a wide ranges of data services by traversing the concept leaves of such a feature tree of the data service.

Other embodiments of the present invention may include provisioning of solutions in response to such feature/concept requests for data services on a client device. Such embodiments contemplate the installation of feature-based solution-related templates on one or more servers. For each feature, the solution-related templates may include at least a solution template describing how results returned for a request for service are to be organized and provided to the client device.

In various embodiments, the solution-related templates may also provide for an index fragment for organizing multiple results, such that multiple results may be provided in fragments for certain client devices, such as wireless mobile devices with small displays. Additionally such fragments may allow for the aggregation of multiple solution components from multiple vendor sources. In other various embodiments, the solution provisioning approach of the present invention may support provisioning of supplemental information while the user waits for a requested solution.

In still other embodiments of the present invention, the solution provisioning approach may support “buttons” for use by the user in viewing the solutions provided. Other further embodiments may provide a solution provisioning approach that supports “actions” to be taken by the user, e.g., purchasing, reserving and so forth (in e.g. the form of solution commands).

Yet further embodiments of the present invention may include a solution provisioning approach that supports the automatic updating of various data structures and/or databases of various applications that support “open” update of their data structures and/or databases, such as favorites, calendars and so forth.

Embodiments of the present invention may include a service-vendor based architecture for services, and vendor provisioning of services, to be added to a client-server based service delivery framework (“framework”). In one embodiment, the framework may include an engine and a service provider application controlling a number of service applications, which in turn interface with a number of vendors in actually providing the services. Any application the engine calls (through the service provider) to fulfill a user request is considered a service application, so long as it compatibly implements the vendor service provision protocols defined by the framework, which in one embodiment is extensible markup language (“XML”) based.

In various embodiments of the present invention, communications in the framework are conducted using the hypertext transfer protocol (“HTTP”). The feature/concept based request and subsequent reply for services are both formed with XML and communicated using HTTP. In such an embodiment, the service provider creates a request object from the incoming XML document, identifies the service class to use by mapping a feature identifier (“FID”) against configuration data, loads the service and passes the request object to the service within the command method specified in the request for service. The service executes the requested command and returns a response object to the service provider application as a return value of the command method. The service provider application then turns the response objects into the appropriate XML document for processing into a solution for the requesting client device. The service typically interfaces with one or more vendors to develop the response. In various embodiments, the service provider includes an application programming interface (“API”) for facilitating services development and interacting with vendors. Such an API may be in any appropriate programming format such as “JAVA” or “.NET” compatible programming languages. The API advantageously extracts the communication layer and XML formation so vendors may focus on the business rules associated with the services being implemented. One implementation of the API is set forth in the above identified application (attorney docket reference 109927-135178).

Embodiments of the present invention may also include an application packaging and branding aspect. The packaging and branding of embodiments of the present invention is particularly suitable for a client server based service delivery environment, where each deliverable service comprises a number of features customized for a “brand”. Similarly, feature trees may be defined to assist in the formulation of request, and feature based solution templates may be defined to process results that return from requests for these feature-based services. These feature trees, solution templates, and so forth may then be used in conjunction with branding elements to form brandable service packs with applications having features and solutions. The application may also include one or more of: documents, cascading style sheets, images, favorites (cross applications updateable items), buttons, colors, fonts, text, labels, and the like.

As previously explained, embodiments of the present invention may operate in a wireless network to communicate between wireless mobile devices and other computing devices and/or servers. It will be appreciated by those of ordinary skill in the art that other networks may be used in addition to a wireless network, e.g., “the Internet” which refers to the collection of networks and routers that communicate between each other on a global level using the Internet Protocol (“IP”) communications protocol (a substantial portion of which is wireline based).

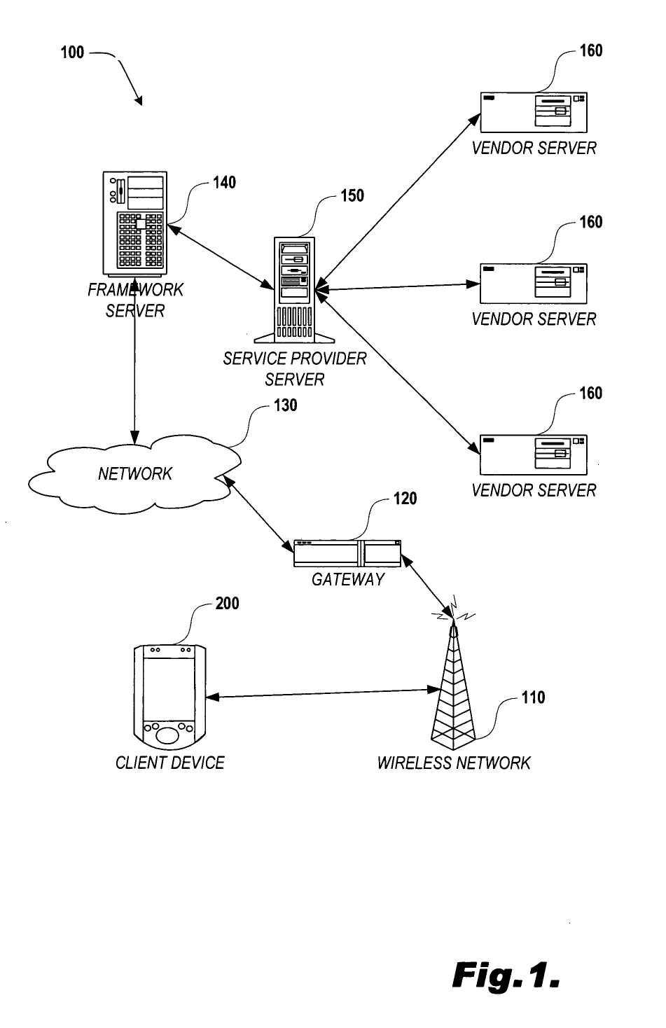

FIG. 1 is a pictorial diagram of an exemplary data service provisioning system (“framework system”) 100 for providing data services to wireless mobile devices such as client device 200 via a wireless network 110 and other networks 130. For ease of illustration, the client device 200 is shown pictorially as a personal data assistant (“PDA”) in FIG. 1, it being recognized that a large number of client devices in a variety of forms would be included in an actual framework system 100 employing embodiments of the present invention. In general, the client device 200 has computing capabilities and may be any form of device capable of communicating with the framework server 140 in various embodiments of the present invention. Thus, while client device 200 is pictorially shown as a PDA, a mobile computer, cellular phone or the like may be equally employed, although these are just representative devices and should be taken as illustrative and not limiting.

The framework system 100 functions in a distributed computing environment that includes a plurality of client devices 200, interconnected by a wireless network 110 via a gateway 120 to other networks 130 to a framework server 140. The framework server 140 in turn is also connected to a service provider server 150 in communication with vendor servers 160. All these communications and connections are interconnected via suitable network connections using suitable network communication protocols. In various embodiments, the service provider server 150 and vendor servers 160 communicate with each other in accordance with an API of one aspect of the present invention. The vendor servers 160 may be registered with service provider server 150. In alternate embodiments, the service provider server 150 and vendor servers 160 may communicate in accordance with open/standard protocols.

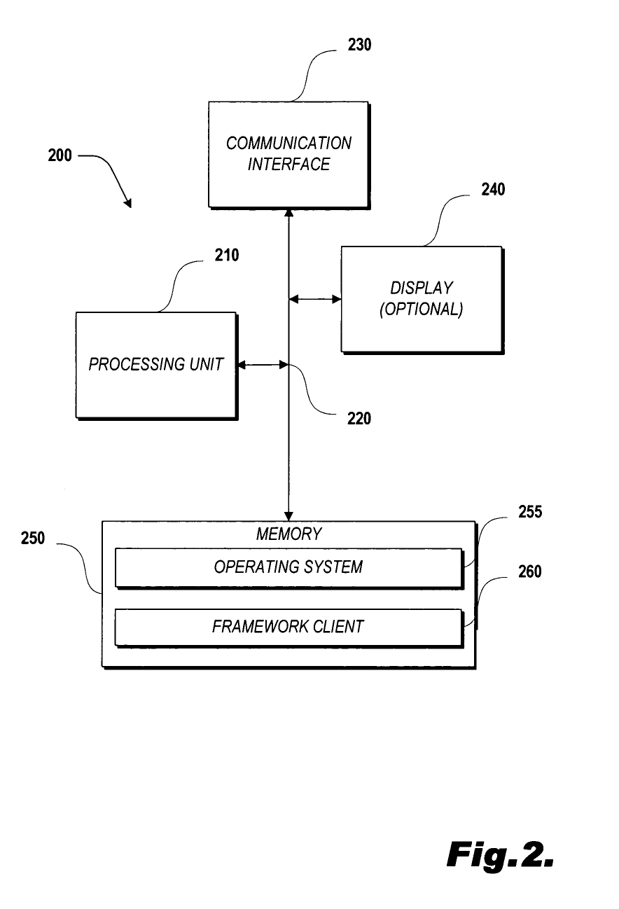

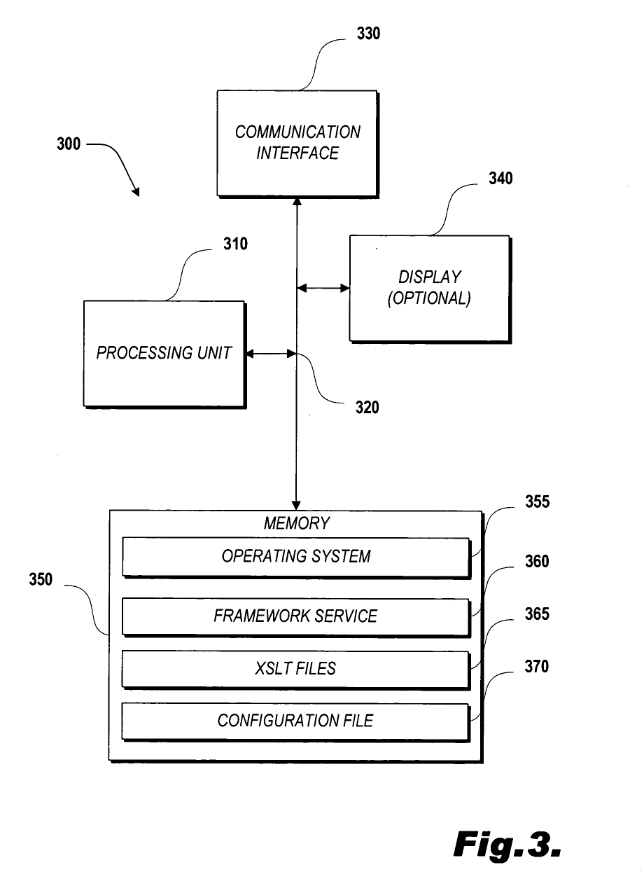

As will be appreciated by those of ordinary skill in the art, the framework server 140 may reside on any device accessible by the client device 200 shown in FIG. 1. An exemplary client device 200 is shown in FIG. 2 and described below. An exemplary combined framework server 300 is shown in FIG. 3 (combined with a service provider server 150) and described below.

It will also be appreciated that while the framework server 140 of the framework system 100 is illustrated as a single device, the framework server 140 may actually comprise more than a single device in an actual system practicing embodiments of the present invention. It will also be appreciated that the framework server 140 may be file servers, database servers or a mixture that includes file servers and database servers. It will further be appreciated by those of ordinary skill in the art, that while the framework server 140 and service provider server 150 are shown as separate devices, in other embodiments of the present invention the framework server 140 and service provider 150 may reside on a single device (as illustrated in FIG. 3). Similarly, the vendor services may be provided via remote vendor servers 160 or may reside on a device sharing either the framework server 140 functionality or service provider server 150 functionality.

FIG. 2 illustrates an exemplary client device 200 suitable for use in embodiments of the present invention. Those of ordinary skill in the art and others will appreciate that the client device 200 may include many more components than those shown in FIG. 2. However, it is not necessary that all of these generally conventional components be shown in order to disclose an enabling embodiment for practicing the present invention. As shown in FIG. 2, the client device 200 includes a communications interface 230 for connecting to remote devices. Those of ordinary skill in the art will appreciate that the communications interface 230 includes the necessary circuitry, driver and/or transceiver for such a connection and is constructed for use with the appropriate protocols for such a connection. In one embodiment of the present invention, the communication interface 230 includes the necessary circuitry for a wireless network connection.

The client device 200 also includes a processing unit 210, a display 240 and a memory 250, all interconnected along with the communications interface 230 via a bus 220. Those of ordinary skill in the art and others will appreciate that the display 240 may not be necessary in all forms of wireless computing devices and, accordingly, is an optional component. The memory 250 generally comprises random access memory (“RAM”), a read only memory (“ROM”) and a permanent mass storage device, such as a disk drive, flash RAM, and the like. The memory 250 stores an operating system 255 and a framework client 260 formed in accordance with embodiments of the present invention. In various embodiments, memory 250 also stores one or more feature trees (not shown), each comprising a number of concept leaves to facilitate local formulation of service requests in the form of goal statements for one or more services, and local rendering of returned solution sets to the service requests, to be described more fully below. As will be apparent from the description to follow. the local formulation of service requests and rendering of returned solution sets may be performed requiring virtually no interactions with external servers, thereby saving air time (in the case of wireless client devices). Further, feature trees are particular suitable for service vendors to brand their services.

Additionally, framework client 260 may also maintain a list (not shown) of data items of various databases of applications (not shown) that support “open” update, i.e. allowing other applications to update these data items. Example of the data items include but are not limited to data items of a calendar application. In various embodiments, framework client 260 also maintains the method calls (not shown) to effectuate the updates. Examples of such methods may include Get and Put methods of a calendar application to allow reading from and writing into the calendar databases.

It will be appreciated that the software components (including the feature trees) may be loaded from a computer readable medium into memory 250 of the client device 200 using a drive mechanism (not shown) associated with the computer readable medium, such as a floppy, tape, DVD/CD-ROM drive, flash RAM or the communications interface 230.

The term “feature” as used herein refers to a prominent, significant, distinctive aspects of offered services, as the term is generally understood by those of ordinary skill in the art of online data service provision. Examples of features may include but are not limited Airline Reservation, Hotel Reservation, Car Reservation, Restaurant Reservation, and Location/Map Services.

The term “concept” as used herein refers to an abstract or generic idea of a feature, generalized from particular instances. It may have 1:1 or 1:n mappings to implementation data structures and/or items. Examples of concepts for an Airline Reservation feature may include but are not limited “departing city”, “arrival city”, “departure date”, “return date” and so forth.

The terms “object” and “methods” as used herein, unless the context clearly indicates to the contrary, are to be accorded their ordinary meanings as understood of those of ordinary skill in the art of object oriented programming.

Although an exemplary client device 200 has been described that generally conforms to conventional computing devices, those of ordinary skill in the art and others will appreciate that the client device 200 may be any of a great number of computing devices capable of communicating remotely with other devices. In various embodiments of the present invention, the client device 200 may be a cellular telephone, PDA, general purpose computing device or the like.

FIG. 3 illustrates an exemplary server 300 suitable for use as a combined framework server 140 and service provider 150 in embodiments of the present invention. Those of ordinary skill in the art and others will appreciate that the combined framework and service provider server 300 may include many more components than those shown in FIG. 3. However, it is not necessary that all of these generally conventional components be shown in order to disclose an enabling embodiment for practicing the present invention. As shown in FIG. 3, the combined framework and service provider server 300 includes a communications interface 330 for connecting to remote devices. Those of ordinary skill in the art will appreciate that the communications interface 330 includes the necessary circuitry, driver and/or transceiver for such a connection and is constructed for use with the appropriate protocols for such a connection. In one embodiment of the present invention, the communication interface 330 includes the necessary circuitry for a wired and/or wireless network connection.

The combined framework and service provider server 300 also includes a processing unit 310, a display 340 and a memory 350, all interconnected along with the communications interface 330 via a bus 320. Those of ordinary skill in the art and others will appreciate that the display 340 may not be necessary in all forms of computing devices and accordingly is an optional component. The memory 350 generally comprises RAM, ROM and a permanent mass storage device, such as a disk drive, flash RAM, or the like. The memory 350 stores an operating system 355, a framework service 360, extensible style sheet language (“XSL”) transformation (“XSLT”) files 365 and a configuration file 370 formed in accordance with embodiments of the present invention. It will be appreciated that the software components may be loaded from a computer readable medium into memory 350 of the combined framework and service provider server 300 using a drive mechanism (not shown) associated with the computer readable medium, such as a floppy, tape, DVD/CD-ROM drive, flash RAM or the communications interface 330.

Although an exemplary combined framework and service provider server 300 has been described that generally conforms to conventional computing devices, those of ordinary skill in the art and others will appreciate that the combined framework and service provider server 300 may be any of a great number of computing devices or clusters of computing devices capable of communicating remotely with other devices. In the latter case, the framework and service provider functions may be executed on separate servers, e.g. 140 and 150.

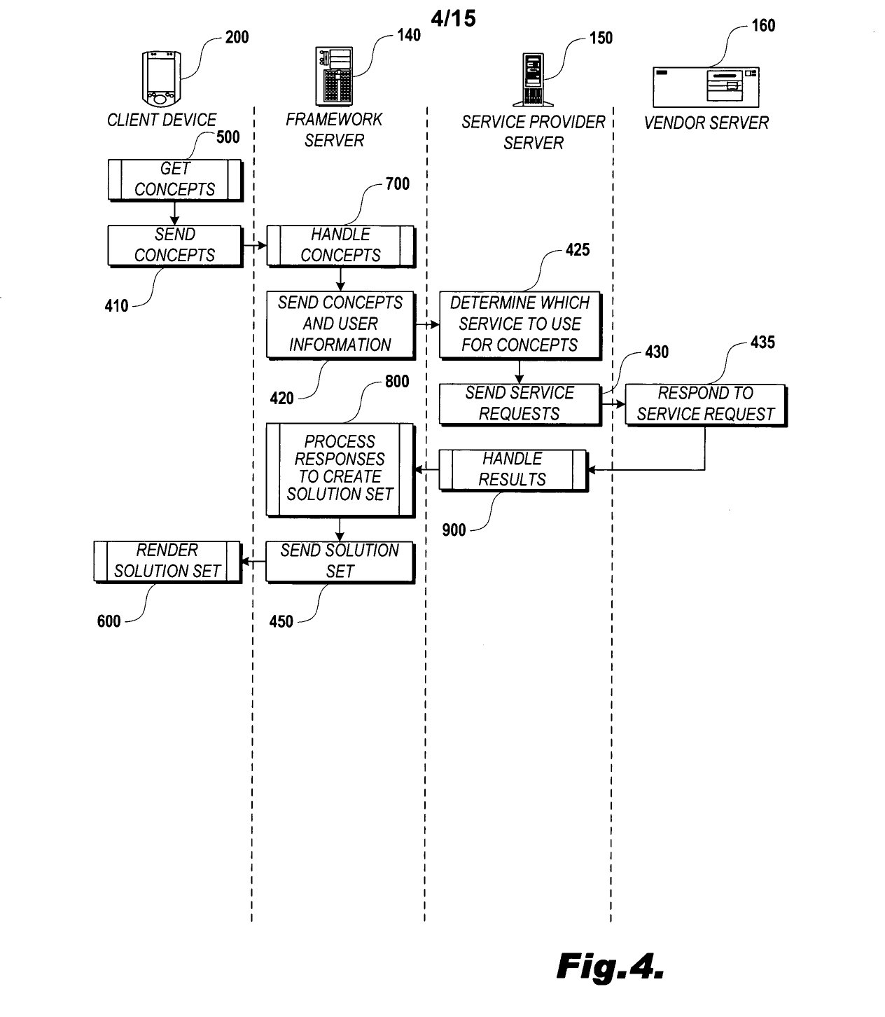

The operation of the feature/concept request formation and data service response formation of the framework system 100 shown in FIG. 1 will be understood by reference to FIG. 4, which includes one exemplary sequence of communication interactions between a client device 200, framework server 140, service provider server 150 and vendor server 160. It will be appreciated by those of ordinary skill in the art, that the communications between the devices illustrated in FIG. 4 may comprise any form of communication connections, including wireless signals (e.g., radio frequency “RF” signals, audio modulated signals, electromagnetic signals of other frequencies, optical signals, or combinations thereof) as well as conventional wire-based signals. Further, framework server 140 may involve multiple service provider servers 150 and in turn, multiple venders 160 in the service of a concept. Similarly, a service provider server 150 may on its own involve multiple vender servers 160 in the service of a concept. However, for ease of understanding, the description to follow will concentrate on the communication between framework server 140 and a service provider server 150, and between a service provider server 150 and a vendor server 160.

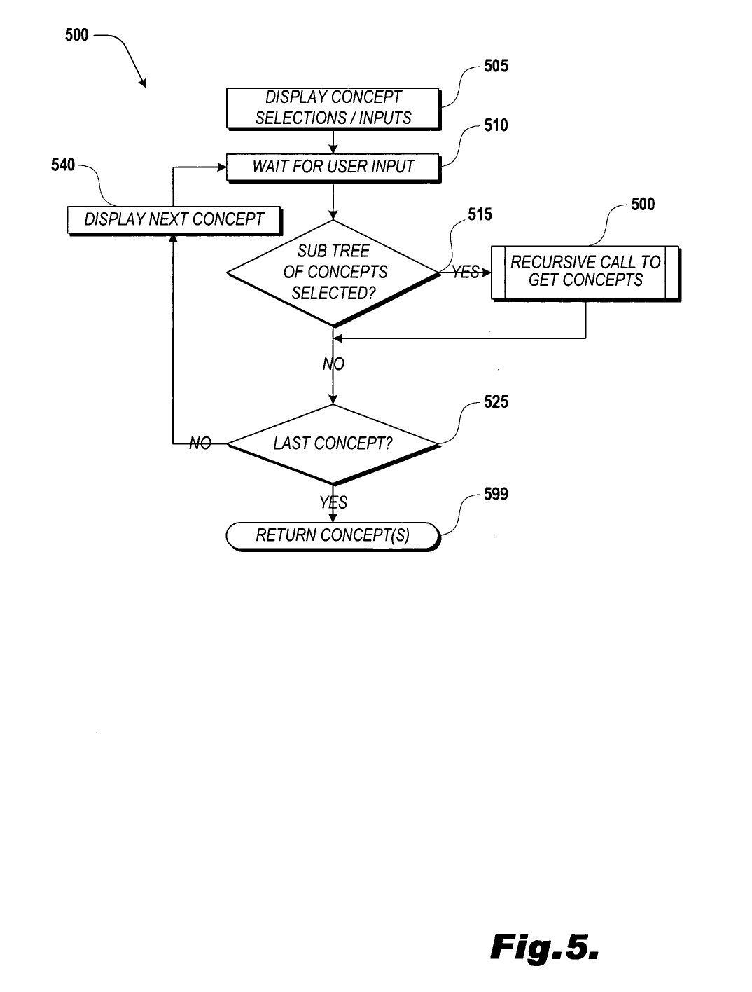

The exemplary communication interactions and processing shown in FIG. 4 begin at subroutine block 500 of framework client 260 on the client device 200 where one or more concepts of a feature are gathered for a data service request in the form of a goal statement. Subroutine 500 is illustrated in FIG. 5 and described in further detail below. The term “goal statement” as used herein refers to an aggregated expression of the concepts of a feature. An example of a goal statement for a Airline reservation feature may be “Flying from the Bay Area into the Chicago area in the middle of this week, and returning in the middle of next week”. Note that in the above example, the concepts of the departure and arrival “cities” and “time” are not particularized to any airport and hour. As will be apparent from the description to follow, the novel concept, goal statement and feature organization of embodiments of the present invention enables the client devices to be substantially sufficient in formulating a data service request without having to consume valuable air time. A factor that makes this possible is the service request in the form of a goal statement having concepts of a feature may be expressed without implementation details of the services (which prior art techniques like URL or SQL queries require).

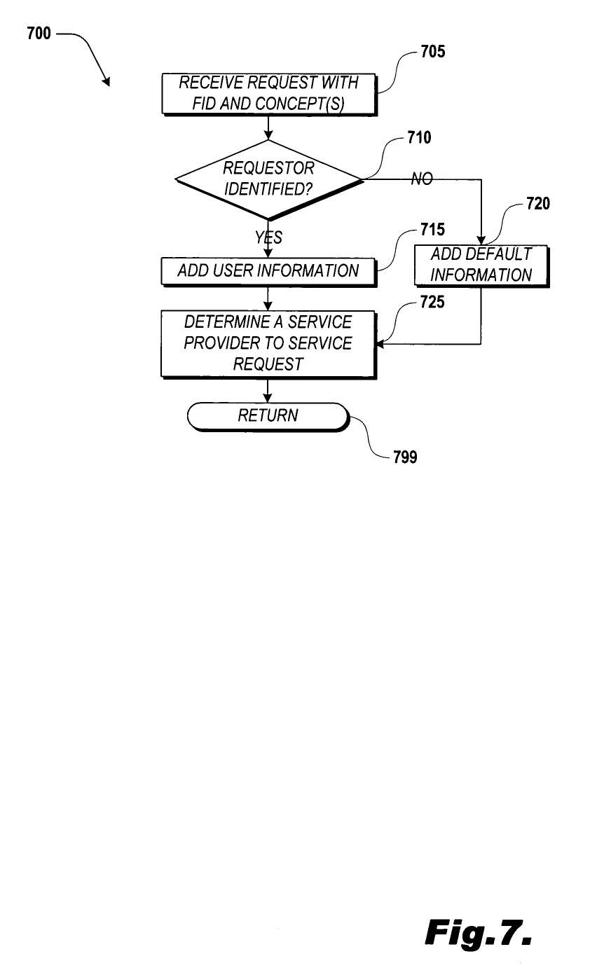

Processing then continues to block 410 where the client device 200 sends the concepts returned from subroutine 500 to the framework server 140. Next, in subroutine block 700, the framework server 140 (more specifically, to a service such as framework service 360) handles the received concepts, e.g., adds user and other “stable” and/or default information to the received concepts. Subroutine 700 is illustrated in FIG. 7 and described below. Once subroutine 700 returns, processing continues to block 420 where the framework server 140 sends the concepts augmented with user information to the service provider server 150. Examples of user and other “stable” and/or default information include but are not limited to, the user's name, addresses, phone numbers, email address, age, social security numbers, and so forth. Thus, while the service requests may be advantageously formulated on the client device, substantially without interaction with external servers, saving air time, the formulation is streamlined to avoid having the user to re-enter stable/default information.

As already noted above, in various embodiments of the present invention the framework server 140 and the service provider server 150 may reside on a single server. In such an embodiment, the framework server and service provider server may be separate processes running on the same physical server.

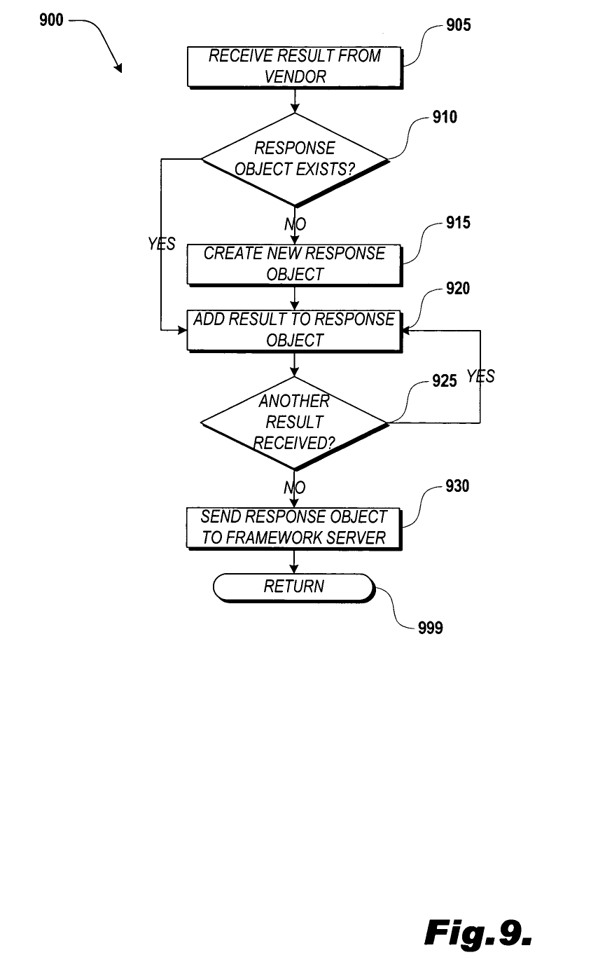

The service provider server 150 (more specifically, framework service 360) is next operative, in block 425, to determine which service to use to respond to the received service request comprising the feature/concepts Next, in block 430, the service provider server 150 formulates one or more service requests for one or more service vendors, and sends the service request (or requests) to the vendor server (or servers) 160 that were determined in block 425. At each vendor server 160 the service request is responded to in block 435, with the response being directed back to the service provider server 150. In subroutine block 900, the service provider server 150 handles received service results. Subroutine 900 is illustrated in FIG. 9 and described below.

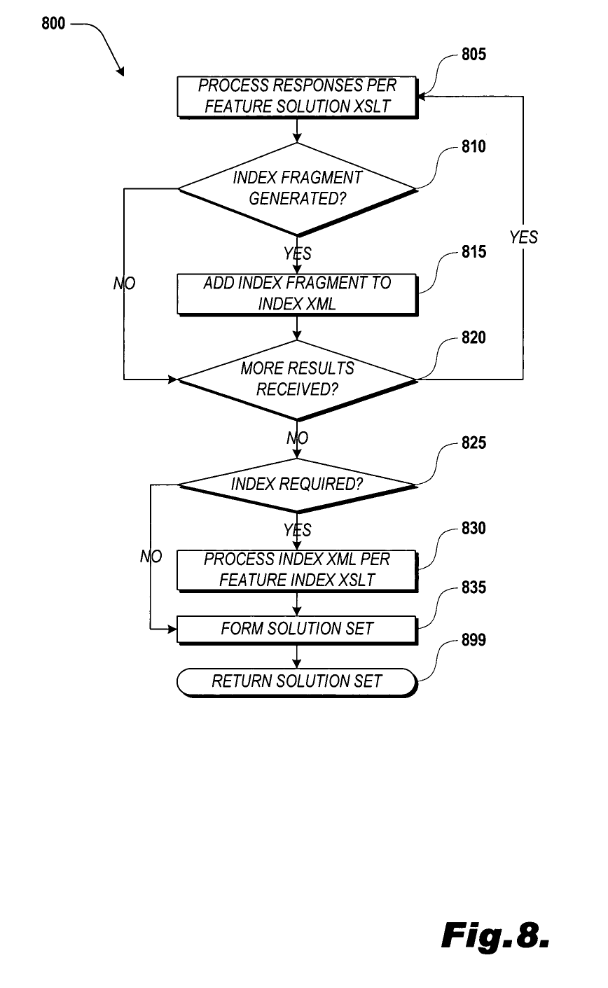

Once subroutine 900 returns, the framework server 140 processes the responses to create a solution set in subroutine block 800. Subroutine 800 is illustrated in FIG. 8 and described below.

In various embodiments, as alluded to earlier, and to be described in more detail below, the service results returned by a service vendor may include commands to be included in the solution set. The service results may also causes one or more new feature tree of concepts to be add to the client device, to allow the user of the client device to formulate a service request of a feature it did not have. For example, a client device may be initially loaded with a feature to make airline reservation. A hotel reservation feature and its concepts may be dynamically added to the client device as part of a reservation solution returned for a reservation request.

In various embodiments, the communications and cooperation with vendor servers 160 are effectuated via an API of one aspect of the present invention. The API advantageously allow multiple vendors to provide the offered services, including multiple vendors providing the same service, an aspect of great benefit to the data service consumers.

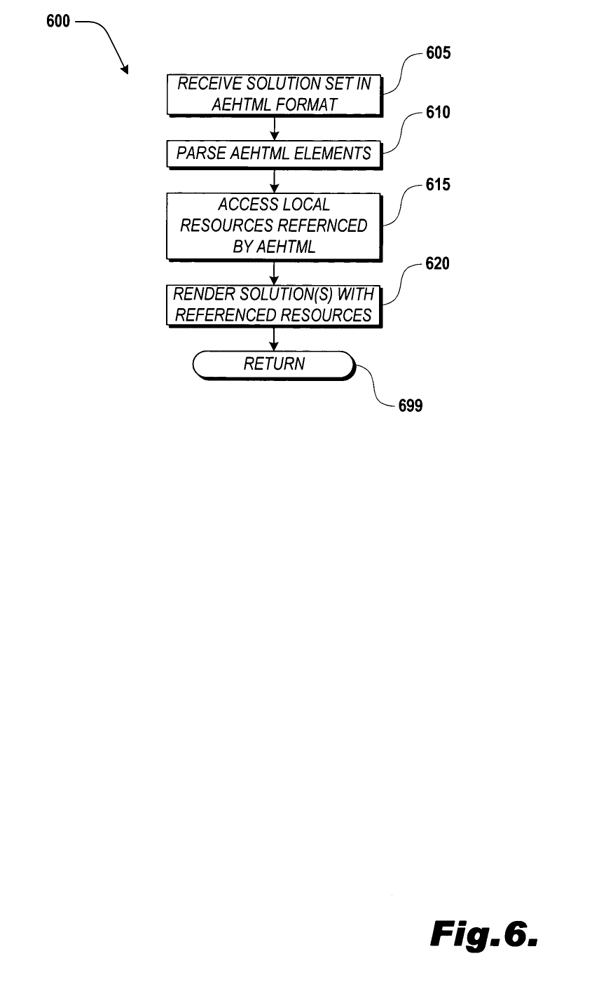

Once subroutine 800 returns with a solution set, in block 450 the framework server 140 sends the solution set back to the client device 200. On the client device 200 the solution set is processed by the framework client 260 and rendered in subroutine block 600, thereby providing a response to the feature/concepts data service request. Subroutine 600 is illustrated in FIG. 6 and described below.

The framework system 100, described herein, includes a client device 200 that gathers concepts to be used in requesting data services from the framework server 140. FIG. 5 is a flow diagram illustrating an exemplary client-side concept gathering subroutine 500 of framework client 260 suitable for implementation by the client device 200. Subroutine 500 begins at block 505, where the first concept selection/input is displayed to a user of the client device 200. Next the subroutine waits for user input at block 510. Once input has been received, processing proceeds to decision block 515 where a further determination is made whether the selection is the root of a sub-tree that requires additional user input. If so, processing continues to a recursive call to the get concepts subroutine 500. If, however, in decision block 515 it was determined that the input received was a concept leaf input, processing continues to decision block 525, where a determination is made whether subroutine 500 is finished getting concepts; if not, the next concept is displayed to the user in block 540 and processing loops back to before block 510. If, however, in decision block 525, it was determined that subroutine 500 is finished getting concepts, processing continues to block 599 where the selected concept or concepts are returned to the location where subroutine 500 was invoked.

In one embodiment of the present invention the results of a client device feature/concepts request are processed and rendered according to subroutine 600. FIG. 6 is a flow diagram illustrating an exemplary client-side result rendering subroutine 600 of framework client 260 suitable for implementation by the client device 200. Subroutine 600 begins at block 605, where a solution set in AEHTML format is received. Each solution in the solution set is an AEHTML file that is a combination of HTML and special AEHTML Elements in XML format. The XSLT that get applied to achieve a solution set in AEHTML format are chosen by the framework server based at least in part on a FID and type of client device 200.

Next the subroutine parses the AEHTML elements in block 610. Once the AEHTML input has been parsed, processing proceeds to block 615 where local resources references by the AEHTML are accessed. The framework client 260 then renders the solution or solutions in the framework set with the referenced local resources in block 620. When a solution is displayed on a client device 200, other resources (e.g., cascading style sheets, buttons, text and images) may combine to display the final solution. Processing then continues to block 699 where the solution set is returned to the point where subroutine 600 was called.

In embodiments of the present invention, the framework server 140 handles incoming feature/concept requests according to the logic of subroutine 700. FIG. 7 is a flow diagram illustrating an exemplary framework server request handling subroutine 700 suitable for implementation by the framework server 140. Subroutine 700 begins at block 705, where a feature/concepts request is received with an FID and at least one concept. The framework server 140 next determines whether the requestor was identified (and accordingly whether identifying information is available) in decision block 710. If so, then processing proceeds to block 715 where user identifying information is added to the feature/concept request. If, however, the requestor was not identified, the processing proceeds to block 720 there default information is added to the feature/concepts request.

Once information either user information or default information has been added to the feature/concepts request, subroutine 700 proceeds to block 725 where a determination is made as to which service provider server 150 will service the feature/concept request. Those of ordinary skill in the art and other will appreciate that if a single service provider server 150 exists, or if a single combined framework server 300 is in use, then all requests would go to the single server. Other determinations may rely on such factors a particular vendors registered with a service provider server 150, or conventional factors, such as load-balancing. Processing then continues to block 799 where processing returns to the point where subroutine 700 was called.

As noted above, the framework server 140 includes processing functionality (embodied e.g. in framework service 360) for processing solutions to requested data services that are to be delivered to a client device 200. Accordingly, FIG. 8 illustrates a response processing subroutine 800 for processing data service responses before providing them to a client device 200. Subroutine 800 begins at block 805 where the response or responses received from the service provider server 150 are processed according to a feature solution XSLT associated with a feature. Next, in decision block 810, a determination is made whether the processed response generated an index fragment. The term “index fragment” as used herein refers to a piece of a multi-part solution. As will be appreciated by those skill in the art, the employment of index fragment advantageously allows the solutions to be presented in a scalable manner, accommodating a wide range of display capabilities of various wireless mobile devices.

If an index fragment was generated, processing continues to block 815 where the index fragment is added to an index XML. The term “index XML” as used herein refers to a multi-part solution data structure. If, however, in decision block 810 (or after adding the index fragment to the index XML) it was determined that no index fragment was generated then processing continues to decision block 820. In decision block 820, a determination is made whether more results were received. If more results were received, processing loops back to block 805 where the additional response is processed per the feature solution XSLT. If, however, in decision block 820 it was determined that no more results were received, processing continues to decision block 825 where a determination is made whether an index required (i.e., a solution with multiple parts has been provided). If so, then in block 830, the index XML is processed per the feature index XSLT (a specific XSLT for processing multi-part solutions for delivery to a client device). If, in decision block 825 (or after processing the index XML per the feature index XSLT), it was determined that an index was not required, processing continues to block 835 where a solution set is formed. Processing then continues to block 899 where the solution set is returned to the point where subroutine 800 was called.

Embodiments of the present invention enable the service provider server 150 to handle incoming vendor results so as to provide the framework server 140 with a response object in which to process solutions for the client device 200. FIG. 9 is a flow diagram illustrating an exemplary service provider server result handling subroutine 900 suitable for implementation by the service provider server 150. Subroutine 900 begins at block 905, where a result is received from a vendor server 160 with at least one result to a feature/concepts request. Processing proceeds to decision block 910 where a determination is made whether a response object exists. If so, then processing proceeds directly to block 920. Otherwise, if no response object exists, then processing proceeds to block 915 where a new response object is created. Next, in block 920, the received response is added to the response object (e.g., by use of an “AppendResult” method from the service provider API). Processing proceeds to decision block 925 where a determination is made whether another result has been received. If so, then processing cycles back to block 920. Once it has been determines in decision block 925 that not more results have been received, processing proceeds to block 930 where the response object is sent to the framework server 150. Subroutine 900 continues to block 999 where processing returns to the point where subroutine 900 was called.

In various embodiments, the framework system 100 also advantageously allows issueable commands to be included as part of the returned solution sets (also referred to as “solution commands.” The solution commands may be inserted or caused to be inserted into the solution sets by the service vendor providing the services or by the framework and/or service provider server 140 and 150.

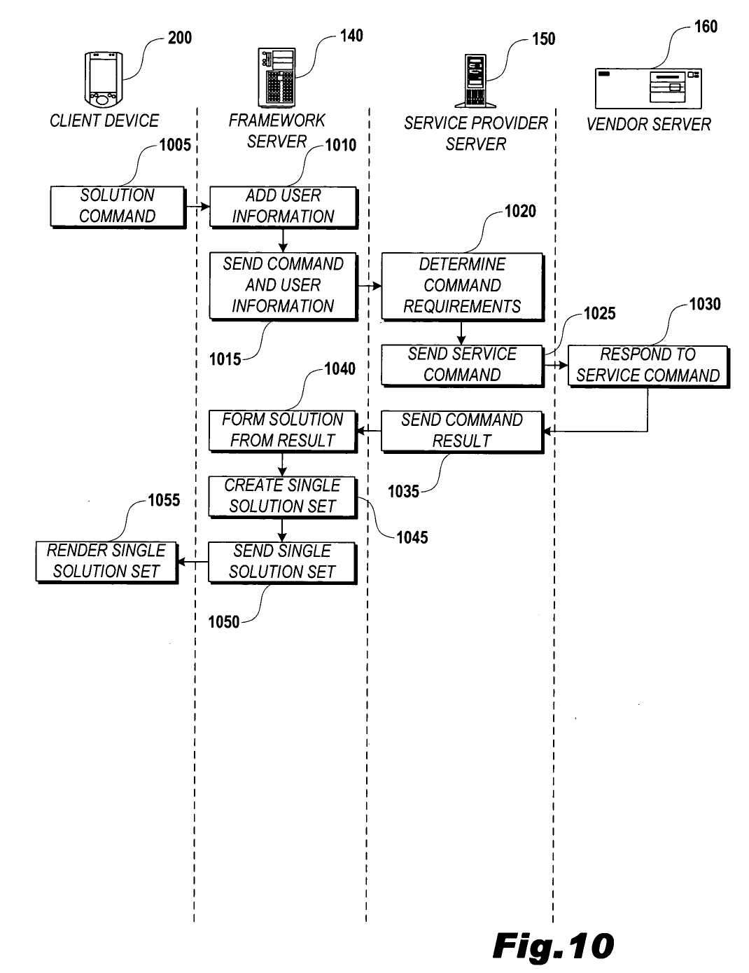

The solution commands are serviced in a similar manner as the feature/concept based service response, as illustrated in FIG. 4. In particular, once a solution has been returned to a client device 200, a command may be then issued in response to the solution. Example commands may include reserving, purchasing, accepting, canceling, modifying a returned solution. Those of ordinary skill in the art and other will appreciate that yet other command may be used in other embodiments of the present invention. FIG. 10 is a flow diagram illustrating an exemplary solution command and response scenario that includes one exemplary sequence of communication interactions and processes with reduced client device communications (and airtime usage) between a client device 200, framework server 140, service provider server 150 and vendor server 160. It will be appreciated by those of ordinary skill in the art, that the communications between the devices illustrated in FIG. 10 may comprise any form of communication connections, including wireless signals as well as conventional wire-based signals.

The exemplary communication interactions shown in FIG. 10 begin at block 1005 where the client device 200 (more specifically, framework client 260) sends a solution command to the framework server 140. Next in block 1010 the framework server 140 may likewise add user and/or other stable/default information to the sent command, and processing continues to block 1015 where the framework server 140 sends the solution commands augmented with user and/or stable/default information to the service provider server 150. The service provider server 150 is then operative, in block 1020, to determine which service to use to respond to the received command. Next, in block 1030, the service provider server 150 formulates one or more service commands for one or more service vendors, and sends the service command(s) to the vendor server(s) 160 associated with the service(s) determined in block 1020. Note that this may or may not be the service vendor(s) who provided the service(s) that led to the solution set including the solution command being processed. At each vendor server 160, each service command is responded to at block 1030 with the response being directed back to the service provider server 150. In block 1035, the service provider server sends the command result(s) to the framework server 140. The framework server 140 processes the result(s) to form a solution and, in block 1040, a single-solution solution set is created. Next, in block 1050, the framework server 140 sends the solution set back to the client device 200. On the client device 200, the single-solution solution set is processed and rendered in block 1055, thereby providing a response to the solution command.

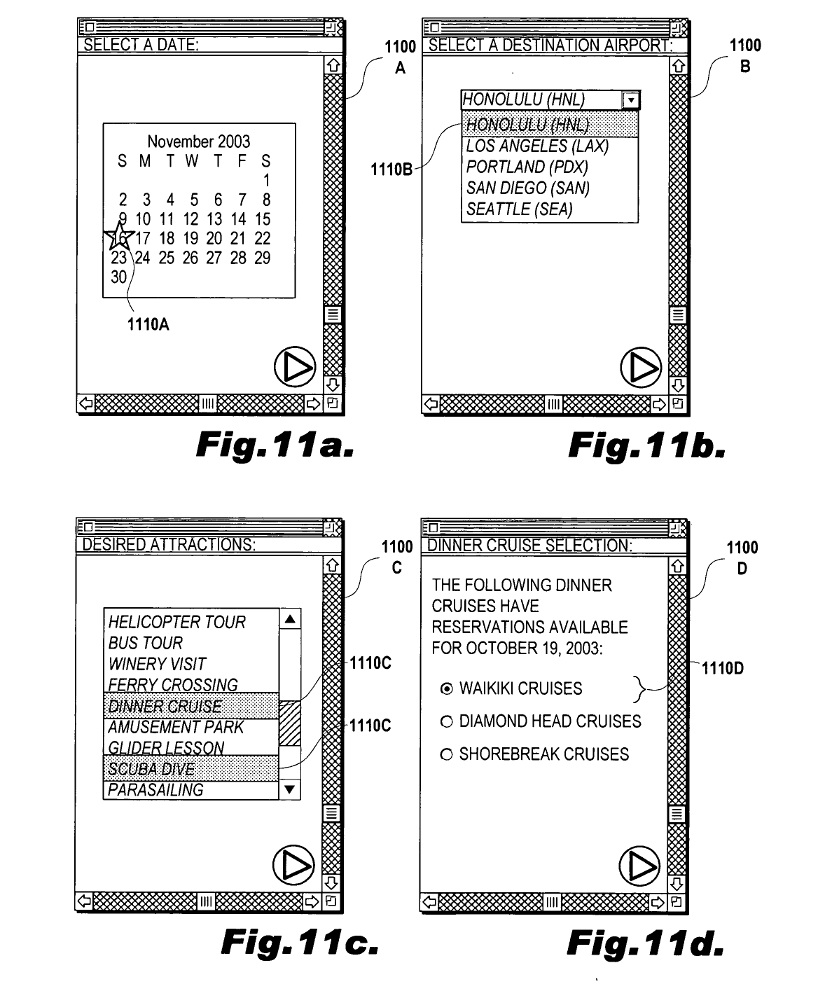

In addition to the diagrams illustrated in FIGS. 4-10 showing the gathering of concepts, commands and provision of solutions, FIGS. 11-13 illustrate alternate end-user views of the concept gathering and solution provisioning aspects of embodiments of the present invention. FIGS. 11a-b illustrate exemplary screen shots of concept gathering screens in a travel feature on a client device 200. FIG. 11a illustrates a selectable calendar screen shot 1100A in which a particular user interface date (a concept) component 1110A has been selected. FIG. 11b illustrates a destination airport (another concept) selection screen 1100B in which a destination airport user interface component 1110B has been selected. FIG. 11c illustrates an attraction selection screen shot 1100C in which attraction (still more concepts) user interface components 1110C have been selected. Finally, FIG. 11d illustrates a dinner cruise selection screen shot 1100D in which a particular dinner cruise (yet another concept) user interface component 1110D has been selected. Note that each concept may map to one or more implementation data structures and/or one or more data fields.

Viewed collectively, screen shots 1100A-D illustrate the gathering of various concepts of the “travel” feature to form a “goal sentence” in a particular feature by using user interface components. Concepts are the elements that are gathered at the client device 200 to determine what a data service request from remote servers. A goal sentence is one way of expressing the combined concepts used in requesting data services. An exemplary goal sentence formed from the concepts shown in FIGS. 11a-d might be: “traveling to Honolulu on Nov. 16, 2003, and requesting a scuba dive and a Waikiki Cruises dinner cruise.” Unlike previous systems, the concepts gathered at the client device 200 are gathered from the previously loaded into the memory 250 of the client device 200. Accordingly, instead of a communication-intensive interaction with remote servers, the concept gather occurs mainly on the client device 200 in embodiments of the present invention.

In some embodiments of the present invention, a goal sentence or a selection of concepts is maintained in a traversable data structure, such that individual concepts may be traversed to and modified. In such an embodiment, and other concepts that were dependent on a modified concept would be modified or removed accordingly.

Those of ordinary skill in the art and others will appreciate that a single goal sentence is not necessarily a complete specification of all aspects of the concepts included in the request. Accordingly, in some embodiments of the present invention, dynamic concepts are used such that incomplete goal sentences may be submitted to the framework server 140 which, possibly in communication with the service provider server 150 and/or the vendor servers 160, may return further queries that will allow a more complete goal sentence to be submitted for the acquisition of data services. FIGS. 11a-d are merely meant as illustrative examples of screenshots in which concepts may be gathered and are not meant to be limiting on the embodiments of the present invention. For example, if a selected feature embodied restaurants, then the concepts gathered for the restaurants feature would relate to the type of actions desired (e.g., recommendations, reservations, take-out, delivery, etc.) as well as relevant restaurant types, locations, etc.

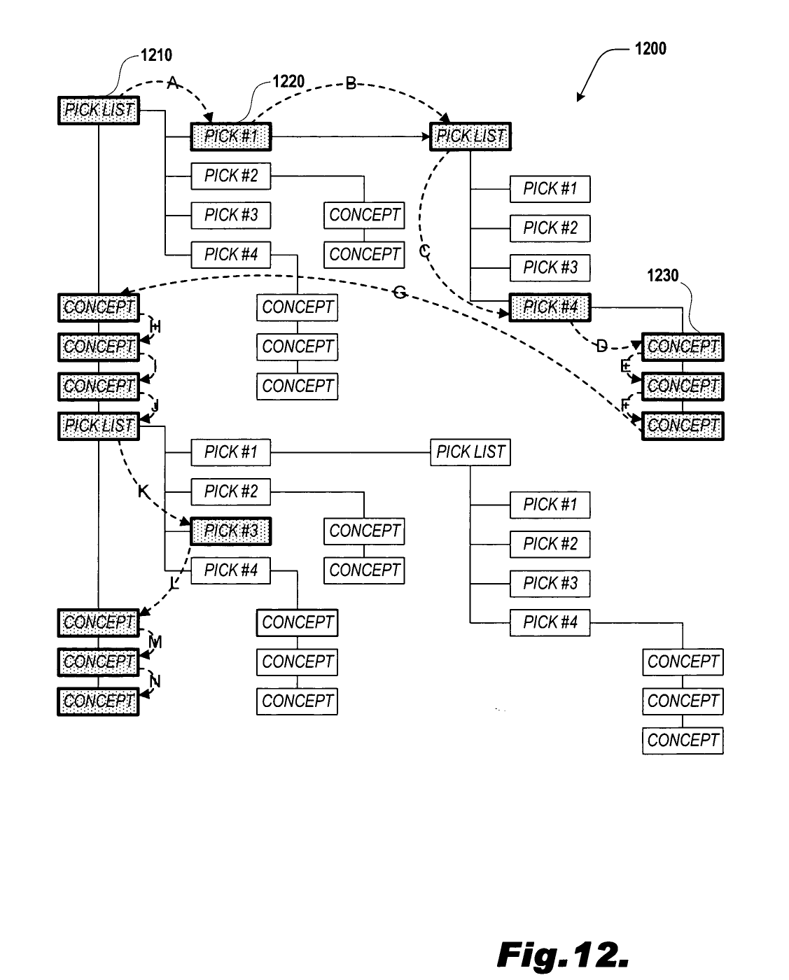

FIG. 12 illustrates an exemplary feature tree 1200 with pick lists 1210 and sub-pick lists 1220 that are used to select leaf nodes/concepts 1230 of the feature tree 1200. The feature tree 1200 illustrated in FIG. 12 shows a selection path indicated by curved arrows A-N in which various pick lists 1210, sub-pick lists 1220 and concepts 1230 are navigated through and selected to form a feature/concepts request such as would be formed in subroutine 500.

In embodiments of the present invention, each feature tree of concepts that is used to select features for requesting data services is expressed in XML. Complementary logic (e.g. generically implemented as part of framework client 260) is used to traverse the feature trees in order to retrieve concepts. In one exemplary embodiment, each feature XML file comprises sections that describe the resources that will be used in the feature, the labels, the behavior and the concept tree that the user will walk to build a request. One such exemplary “schema” is illustrated in Table 1 below.

TABLE 1

<!ELEMENT category (#PCDATA)>
<!ELEMENT cmd (#PCDATA)>
<!ELEMENT concepts (r | mail)>
<!ELEMENT label EMPTY>
<!ATTLIST label

txt CDATA #REQUIRED
icon CDATA #REQUIRED
view (icon | list | menu) #IMPLIED

>
<!ELEMENT logo EMPTY>
<!ATTLIST logo

id CDATA #REQUIRED
pos (b | t) #REQUIRED

>
<!ELEMENT mail (cmd)>
<!ATTLIST mail

y CDATA #REQUIRED

>
<!ELEMENT r EMPTY>
<!ATTLIST r

g CDATA #IMPLIED
y CDATA #IMPLIED
p CDATA #IMPLIED
t CDATA #IMPLIED
f CDATA #IMPLIED
fs (0 | 1) #IMPLIED

>
<!ELEMENT resource (category, ui, rsources?, concepts)>
<!ATTLIST resource

t CDATA #REQUIRED
id CDATA #REQUIRED
ver CDATA #REQUIRED
fmt CDATA #IMPLIED
mod CDATA #IMPLIED
sz CDATA #IMPLIED

>
<!ELEMENT resources (rsc*)>
<!ELEMENT rsc EMPTY>
<!ATTLIST rsc

t (css | img) #REQUIRED
id CDATA #REQUIRED

>
<!ELEMENT ui (label+, logo?)>
<!ATTLIST ui

reqcount CDATA #IMPLIED

An exemplary XML document conforming to the schema shown in Table 1 is also illustrated below.

TABLE 2
<resource fmt=“xml” id=“flower” mod=“200204090802” sz=“7496” t=“feature” ver=“0”>

<category>Shopping</category>
<ui>

<label icon=“actionflowers_1st” txt=“Flowers” view=“list”/>
<logo id=“actionflowers_lgo” pos=“b”/>

</ui>
<resources>

<rsc id=“_contact_1st” t=“img”/>
<rsc id=“def2_bl” t=“img”/>
<rsc id=“actionFlowers_css” t=“css”/>
<rsc id=“actionFlowers_ico” t=img”/>
<rsc id=“actionFlowers_lgo” t=“img”/>
<rsc id=“actionFlowers_hdr_idx” t=“img”/>
<rsc id=“actionFlowers_hdr_sol” t=“img”/>
<rsc id=“actionFlowers_btn_select” t=“img”/>
<rsc id=“actionFlowers_btn_purchase” t=“img”/>
<rsc id=“actionFlowers_btn_view” t=“img”/>
<rsc id=“actionFlowers_A14-BPC” t=“img”/>
<rsc idactionFlowers_A16-AB” t=“img”/>
<rsc idactionFlowers_A17-PMU” t=“img”/>
<rsc idactionFlowers_A18-TAB2” t=“img”/>
<rsc idactionFlowers_C9-2985” t=“img”/>
<rsc idactionFlowers_D8-3062” t=“img”/>
<rsc idactionFlowers_D9-3072” t=“img”/>
<rsc idactionFlowers_D10-3047” t=“img”/>
<rsc idactionFlowers_D11-3037” t=“img”/>
<rsc idactionFlowers_A14-BPC_big” t=“img”/>
<rsc idactionFlowers_A16-AB_big” t=“img”/>
<rsc idactionFlowers_A17-PMU_big” t=“img”/>
<rsc idactionFlowers_A18-TAB2_big” t=“img”/>
<rsc idactionFlowers_C9-2985_big” t=“img”/>
<rsc idactionFlowers_D8-3062_big” t=“img”/>
<rsc idactionFlowers_D9-3072_big” t=“img”/>
<rsc idactionFlowers_D10-3047_big” t=“img”/>
<rsc idactionFlowers_D11-3037_big” t=“img”/>

</resources>
<concepts>

<r>

<ord f=“Flowers to ”>

<how g=“Arrange for” p=“How would you like to order?” y=“pk1”>

<occ i=“def2_bl” p=“Choose a Bouquet:” t=“By Bouquet Name” y=“pk1”>

<flw data=“D11-3037” g=“ a <a>Stunning Beauty</a> bouquet” i=“def2_bl”

t=“Stunning Beauty Bouquet”/>

<flw data=“A14-BPC” g=“ a <a>Birthday Party</a> bouquet” i=“def_2bl”

t=“Birthday Party Bouquet”/>

<flw data=“A16-AB” g=“ an <a>Anniversary</a> bouquet” i=“def2_bl”

t=“Anniversay Bouquet”/>

<flw data=“D10-3047” g=“ a <a>Whirlwind Romance</a> bouquet” i=“def2_bl”

t=“Whirlwind Romance Bouquet”/>

<flw data=“A18-TAB2” g=“ a <a>Thanks A Bunch</a> bouquet” i=“def2_bl”

t=“Thanks A Bunch Bouquet”/>

<flw data=“A17-PMU” g=“ a <a>Pick Me Up</a> bouquet” i=“def2_bl” t=“Pick

Me Up Bouquet”/>

<flw data=“D9-3072” g=“ a <a>Basket of Cheer</a> bouquet” i=“def2_bl”

t=“Basket of Cheer Bouquet”/>

<flw data=“D8-3062” g=“ a <a>Beloved</a> bouquet” i=“def2_bl” t=“Beloved

Bouquet”/>

<flw data=“C9-2985” g=“ a <a>Blooming Masterpiece</a> bouquet” i=“def2_bl”

t=“Blooming Masterpiece Bouquet”/>

</occ>
<get g=“ flowers” i=“def2_bl” t=“By Seeing Picture”/>

</how>

<who p=“Send flowers to whom?” y=“pk1”>

<adr i=“def2_bl” t“Enter Name and Adress”>

<nam g=“ for <a> %string% </a>” p=“Recipient's Name?” y=str“ f=”<a>

% string % </a>“>

<str mxc=”50“/>

</nam>
<loc p=”Delivery Address?“ y=”pk1“>

<adr fav=“loc” i=”ftr_addr“ t=”Enter An Adress“ y=df”>

<df id=“loc” t=“db”>

<select ID=“Select1” NAME=“Select1”>

<col exp=“U|?” id=“region”/>
<col exp=“*” id=“city”/>

</select>
<elements>

<street1 elm=“1” fav=“st1” lbl=“Street” mxc=“40”

req=“2” set=“1;2;3”/>

<city dbc=“city” dsp=“1” elm=“2” fav=“state”

mxc= “40” req=“2” set=“1;3”/>

<stateProv dbc=“state” dsp=“2” elm=“1” fav=“state”

mxc=“2” req=“2” set=“1;3”/>

<postalCode elm=“1” fav=“post” lbl=“Zip” mxc=“5”

req=“2”set=“1;2”/>

<region dbc=“region” def=“?” fav=“region”/>

</elements>
<echo>

<set g=“at <a>%street1%, %city%, %stateProv%</a>” id=“1;3”/>
<set g=“at <a>%street1% (%postalCode%)</a>” id=“2”/>

</echo>
<fav>

<set g=“%firstName%” id=“1;2;3”/>

</fav>

</df>

</adr>
<pim i=“ftr_cont” t=“Use Address from %pim% Contact” y=“df”>

<df id=“cdb” t=“ct”>

<select ID=“Select2” NAME=“Select2”>

<col exp=“*” id=“show”/>

</select>
<elements>

<disp1 dbc=“disp1”dsp=“1”/>
<disp2 dbc=“disp2” dsp=“2”/>
<street1 dbc=“st1” fav=“st1” req=“2” set=“1;2;3”/>
<city dbc=“city” fav=“city” req=“2” set=“1;2”/>
<stateProv dbc=“state” fav=“state” req=“2” set=“1;2”/>
<postalCode dbc=“post” fav=“post” req=“2” set=“1;3”/>

</elements>
<echo>

<set g=“ at <a>%street1%</a>” id=“1;2;3”/>

</echo>
<fav>

<set g=“%street1%” id=“1;2;3”/>

</fav>

</df>

</pim>
<fadr i=“usfav” t=“%_name%” y=“ldb”>

<ldb id=“fw_labels” t=“fav”>

<select ID=“Select3” NAME=“Select3”>

<col exp=“addr” id=“type”/>

</select>
<sort>

<col desc=“0” id=“_name”/>

</sort>
<elements>

<name dbc=“_name” req=“2” set=“1”/>
<guid dbc=“guid” req=“2” set=“2”/>

</elements>
<echo>

<set f=“ %name%” g=“ to <a>%name%</a>” id=“1”/>

</echo>

</ldb>

</fadr>
<fpl i=“usfav” t=“%_name%” y=“ldb”>

<ldb id=“loc” t=“fav”>

<select ID=“Select4” NAME=“Select4”>

<col exp=“*” id=“region”/>

</select>
<sort>

<col desc=“1” id=“_usedate”/>

</sort>
<elements>

<_name dbc=“_name” req“2” set=“1;2;3”/>
<street1 elm=“1” fav=“st1” lbl=“Street” mxc=“40” req=“2”

set=“1;2;3”/>

<city dbc=“city” dsp=“1” elm=“2” fav=“city” mxc=“40” req=“2”

set=“1;3”/>

<stateProv dbc=“state” dsp=“2” elm=“1” fav=“state” mxc=“2” req=“2”

set=“1;3”/>

<postalCode elm=“1” fav=“post” lbl=“Zip” mxc=“5” req=“2”

set=“1;2”/>

</elements>
<echo>

<set g=“ to <a>%_name%</a> address” id=“1;2;3”/>

</echo>

</ldb>

</fpl>

</loc>

</adr>
<cot i=“_contact_lst” t=“Choose Contact From %pim%”>

<pim i=“ftr_cont” y=”df>

<df id=“cdb” t=”ct”>

<select ID=“Select5” NAME=“Select5”>

<col exp=“*” id=”show”/>

</select>
<elements>

<disp1 dbc=“disp1”dsp=“1”/>
<disp2 dbc=“disp2” dsp=“2”/>
<firstName dbc=“f_name” fav=“f_name” req=“2” set=“1;2;3”/>
<lastName dbc=“l_name” fav=“l_name” req=“2” set=“1;2;3”/>
<street1 dbc=“st1” fav=“st1” req=“2” set=“1;2;3”/>
<city dbc=“city” fav=“city” req=“2” set=“1;2”/>
<stateProv dbc=“state” fav=“state” req=“2” set=“1;2”/>
<postalCode dbc=“post” fav=“post” req=“2” set=“1;3”/>

</elements>
<echo>

<set f=“%firstName% %lastName%” g=“ <a>%firstName%

%lastName% <a> at <a>%street1%</a>” id=“1;2;3”/>

</echo>
<fav>

<set g=“%street1%” id=“1;2;3”/>

</fav>

</df>

</pim>

</cot>

</who>
<dat g=“ on <a>%date%</a>” p=“Delivery date?” r=“1” y=“d”>

<d dd=“1” mnr=“1” mxr“120”/>

</dat>
<asm p=“Sign it with a message?” y=“pk1”>
<nom g=“ with <a>no message</a>” i=“gen_n” t=“No - Just My Name”/>
<msg fav=“flower_note” g=“ with a <a>message</a>” i=“gen_y” p=“Message:”

t=“Yes - Include a Message” y=“str”>

<str fav=“string” mxc=“255”/>

</msg>

</asm>
<asi p=“Any special instructions?” y=“pk1”>

<noi g=“, and <a>no special instructions</a>.” i=“gen_n” t=“No”/>
<ins fav=“flower_request” g=“, and <a>special instructions</a>.” i=“gen_y”

p=“Special instructions:” t=“Yes - Include Instructions” y=“str”>

<str fav=“string” mxc=“255”/>

</ins>

</asi>

</ord>

</r>

</concepts>

</resource>

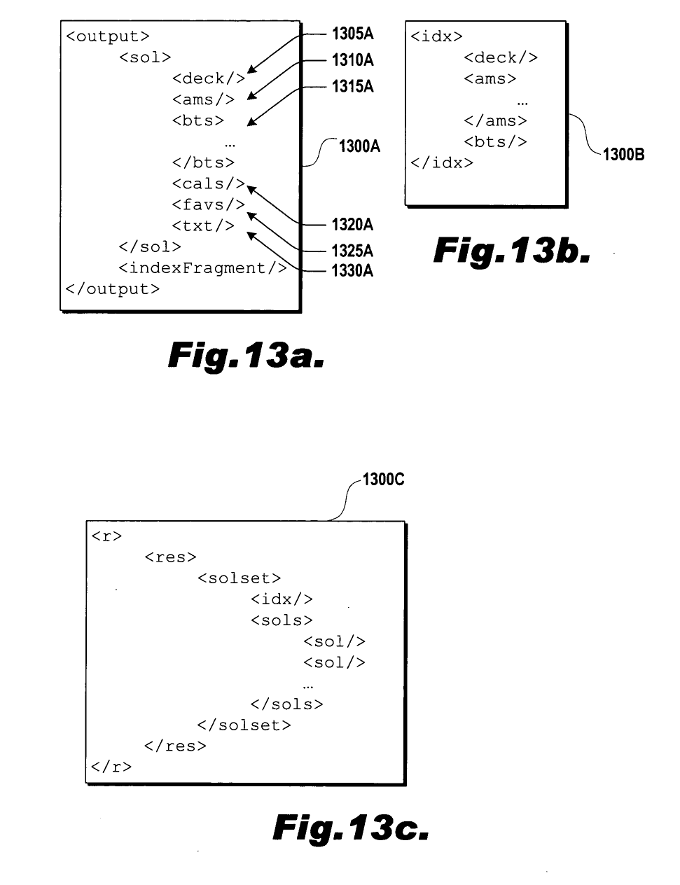

FIGS. 13a-c illustrate exemplary solution structures 1300A-C. FIG. 13a illustrates an XML embodiment of return results where a result from the service provider server 150 has been processed through a solution XSLT to form AEHTML output at the framework server 140. The various elements of the solution structure 1300A included a “deck” of html files 1305A, a custom menu 1310A, custom buttons 1315A, calendar information 1320A, favorites information 1325A and text information 1330A. These elements are then processed at the client device to automatically updating of various data structures and/or databases on the client device 200. The client device may contain various applications that support “open” update of their data structures and/or databases, such as favorites, calendars and so forth. The framework client 260 is operative to identify, and update with updated information, the various applications' data structures and/or databases on the client device 200.

FIG. 13b illustrates the resulting processing for an index fragment that has been processed through the index XSLT to form the formatted index fragment 1300B. FIG. 13c illustrates a combined XML document with one or more solutions and/or indices that are provided as a solution set back to the client device 200 from the framework server 140. Thus, as described earlier, the solution sets of embodiments of the present invention are particular scalable for a wide range of wireless mobile communication devices with a wide range of display capabilities. The exemplary API include various default classes and methods. Among them are the following classes, each having appropriate methods:

AnswersResponse—This class is a container for one or more results as well as auxiliary data.

BinaryResource—This class represents a binary resource.

BooleanResponse—This class represents a Boolean (true or false) response.

ClientInfo—This class represents information about the client making the request.

CodeResponse—This class represents a numeric code response.

Concepts—This class represents concepts.

ConceptsResponse—This class represents a concepts response.

ConceptValues—This class represents the values posted by the client as a result of submitting concepts to the server.

ConfigFile—This class represents an XML configuration file for a plugin.

DeckResponse—This class represents an HTML deck response, which is displayed as rich markup on the client.

Device—This class represents a client device.

Devices—This class represents a set of client devices.

Identity—This class represents a person's name broken out into first name, last name, etc.

ImageResource—This class represents an image (graphic) resource.

InfoRequest—This class represents the XML content returned by an IServiceinfo instance in response to GetInfoRequest.

InfoRequestResponse—This class represents an “info request” response, which is returned by GetInfoRequest.

InfoResponse—This class represents an info response (sometimes called an “action info” response).

Message—This class represents a message.

MessageResponse—This class represents a message response.

Resource—This is the base class for all types of resources.

ResourceReference—This class represents a resource reference, which is a description or “pointer” to an actual resource.

ResourcesResponse—This class represents a response of zero or more resources.

Response—This is the base class for various responses sent to the engine.

Result—This class represents a result for managing state in your plugin as well as providing input to various XSLT transformations.

User—This class represents an end user of the framework.

UserDataResponse—This class represents a user data response.

One embodiment of the present invention is directed to providing a programming interface for the service provider server (or a service provider service on another server) that will enable vendors to integrate their communications with the service provider server 150. The programming interface in one exemplary embodiment of the present invention is an API with specific data service functions for managing a multitude of data services provided within the framework system 100. One exemplary embodiment of such an API is described in the incorporated API appendix. However, those of ordinary skill in the art and others will appreciate that the API description is merely one example of a programming interface suitable for servicing the data service provision in the framework system 100 and that, within the scope and spirit of the present invention, other APIs are possible.

Those of ordinary skill in the art and others will appreciate that there are many possible API function calls that may be made in a data service provisioning system such as the framework system 100. The incorporated API appendix includes a number of exemplary API function calls. Those of ordinary skill in the art and others will appreciate that both more and fewer API function calls (and classes) may be employed in other embodiments of a framework system 100, without departing from the spirit and scope of the present invention.

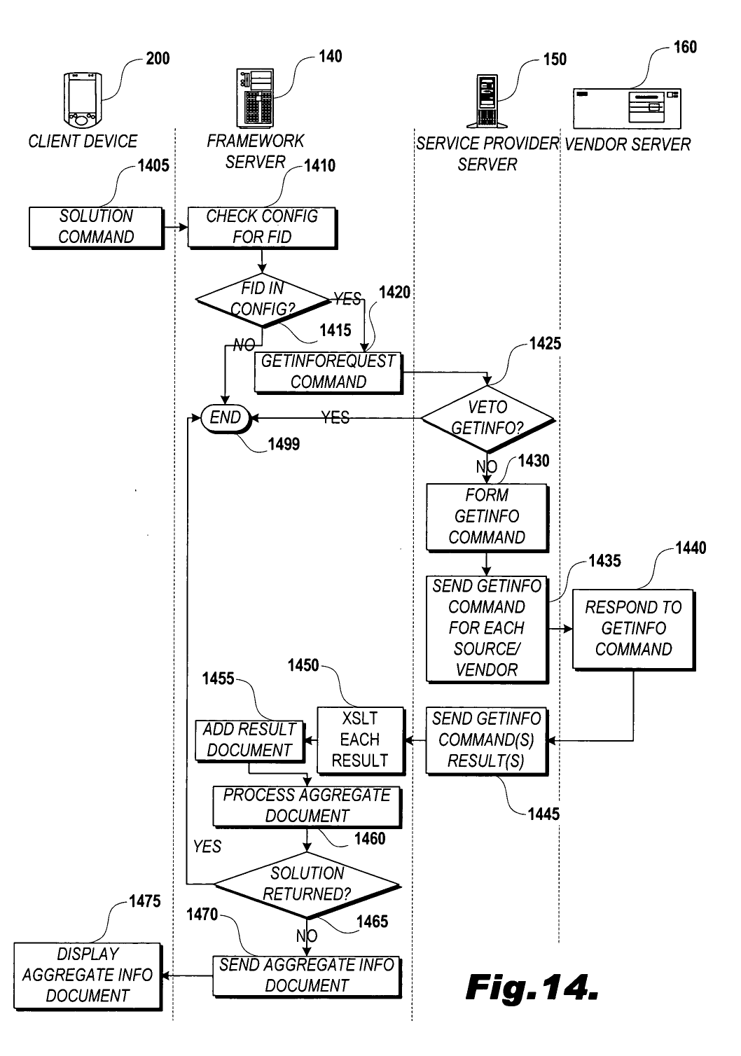

In various embodiments, the framework system 100 also allows the provision of supplementary information, e.g. by framework server 140, while the client device 200 is wait for answers to the service requests and/or solution commands. FIG. 14 illustrates the supplementary information provisioning services of the framework system 100 shown in FIG. 1. FIG. 14 includes one exemplary sequence of communication interactions between a client device 200, framework server 140, service provider server 150 and vendor server 160. It will be appreciated, by those of ordinary skill in the art, that the communications between these devices may comprise any form of suitable wireless and/or wired communications signals.

The exemplary communication interactions and processing shown in FIG. 14 begin with the client device 200 sending a solution command in block 1405 to the framework server 140. The framework server 140 then checks for the FID in a configuration file to identify the feature associated with the solution command in block 1410. Next, in decision block 1415, a determination is made whether the FID was found in the configuration file.

If, in decision block 1415, it was determined that the FID was in the configuration file and accordingly the appropriate feature has been identified then, in block 1420, a get information request command is sent to the service provider server 150. If, however, in decision block 1415, it was determined that the FID was not found in the configuration file 370, processing ends at block 1499 and no supplemental information is returned to the client device 200.

Once a service provider 150 receives a get info request command then in decision block 1425 a determination is made whether to veto the get info request. If the get info request is vetoed, processing also ends at block 1499 and no supplemental information is returned to the client device 200. If, however, in decision block 1425, it was determined not to veto the get info request, processing continues to block 1430 where the get info command is formed. Next, in block 1435, the get info command is sent for each source/vendor that will be used to get the supplemental information. The vendor server (or servers in the case of multiple get info commands) 160 responds to the get info command in block 1440. The response to the get info command is sent back to the service provider server 150. At the service provider server 150 the get info command result (or possibly multiple results if more than one result is returned from a command or more than one command was issued) is sent, in block 1445, to the framework server 140.

In block 1450, the framework server applies an XSL transformation to each result. These transformed results are then passed to block 1455, which adds the results to an aggregate document. In block 1460, the aggregate document is processed to form the supplemental information to be provided to a client device 200.

Next in decision block 1465, a determination is made whether a solution was already returned to the client device from their initial request for information (non-supplemental information). If so, processing ends at block 1499 and no supplemental information is returned to the client device 200. If, however, in decision block 1465 it was determined that no solution has yet been returned to the client device 200, processing proceeds to block 1470 where the aggregated supplemental information is sent to the client device 200. In block 1475 the client device displays the aggregated supplemental information document.

In addition to requesting and providing data services, embodiments of the present invention provide further customization and localization of both concept-gathering interfaces as well as solutions provided in response to data service requests. Accordingly, in some embodiments of the present invention, “packs” are provided to serve as containers for a collection of one or more applications. Packs are located on the highest level of the hierarchical tree and therefore require minimal immediate resources. Packs provide the ability for branding and generic control over the look and feel of the data services that are requested by and provided to the client device 200. In one exemplary embodiment, a pack directory contains XML files that describe an interface with particular branding, static documents, and resources (style sheets, applications, etc.) that will be used in a pack. By using XML and the hierarchical resource structures of the present invention it is possible to provide both data services and a user interface that conforms to the requirements of the service providers and/or local requirements of a client device (e.g., screen size, language, color depth, screen resolution, sound capabilities, network connection, user specified preferences, marketing initiatives, and the like).

For example, a pack branding a number of applications may be created as follows in Table 3.

TABLE 3

<resource t=“pack” id=“rumpus” ver=“0”>

<ui>

<packName>My ActionEngine</packName>
<!-- desktop icon -->
<label icon=“default_01” txt=“My ActionEngine”
view=“icon”/>
<!-- logo/branding -->
<logo id=“br_ae_logo” pos=“b”/>

</ui>
<!--

Documents.

-->
<docs>

<doc id=“eula” val=“ae_eula”/>
<doc id=“about” val=“ae_about”/>
<doc id=“send” val=“ae_send”/>;
<doc id=“sending” val=“ae_sending”/>
<doc id=“sign-up” val=“ae_sign-up”/>

</docs>
<tags>

<tag id=“client” val=“My Action Engine”/>
<tag id=“client_pos” val=“My Action Engine's”/>
<tag id=“sup_phone” val=“1-866-SUPPORT”/>
<tag id=“sup_mail” val=“support@actionengine.com”/>
<tag id=“sup_url” val=
“http://www.actionengine.com/support”/>

</tags>
<!--

External resources.

-->
<resources>

<rsc t=“catalog” id=“rumpus”/>
<rsc t=“fav” id=“fw_labels”/>
<rsc t=“css” id=“mycasio_css”/>
<rsc t=“css” id=“actioninfo_css”/>
<rsc t=“css” id=“signup_css”/>;
<rsc t=“img” id=“actioninfo_hdr”/>
<rsc t=“img” id=“ae_driven_tagline”/>
<rsc t=“img” id=“ae_msg_send”/>
<rsc t=“img” id=“ae_msg_sign-up”/>
<rsc t=“img” id=“ae_msg_results”/>
<rsc t=“img” id=“ae_send_hdr”/>
<rsc t=“img” id=“ae_sending”/>
<rsc t=“img” id=“ae_home_hdr”/>
<rsc t=“img” id=“ae_about_hdr”/>

...
</resources>
...

</resource>

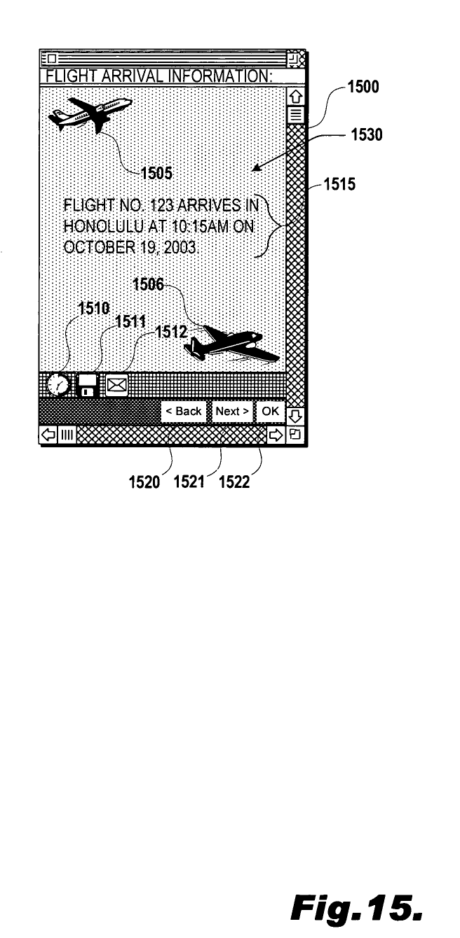

FIG. 15 illustrates an exemplary screen shot 1500 having branded elements that could be modified in accordance with embodiments of the present invention. The screen shot 1500 includes images 1505, 1506, customizable icons 1510-1512; custom text 1515; custom background 1530; and interface specified buttons 1520-1522. Image 1505 may e.g. be the image of an airline or an alliance of airlines providing the reservation services. Those of ordinary skill in the art and others will appreciate that the screen shot 1500 is merely one exemplary screen shot having features that may be customizable to present a consistent branding experience to a consumer of data services in accordance with embodiments of the present invention. Those of ordinary skill in the art and others will appreciate that other brand invoking information may be included, such as cascading style sheets, themes and the like.

Although various embodiments of the present invention have been illustrated and described, it will be appreciated that changes could be made without departing from the spirit and scope of the invention as defined by the appended claims. In particular, it will be appreciated that while the processes and communication interactions of the present invention have been described in a particular order, those of ordinary skill in the art and others will appreciate that other orders of processes and/or communication interactions will also fall within the spirit and scope of the present invention.

1. A method comprising:
defining a user interface of a service including defining of a branding element of the service;
defining a plurality of features of the service, each feature having one or more concepts, and associating the features with the user interface;
receiving a service request expressed in terms of one or more concept of one or more of the associated features;
providing a solution to the service request employing the user interface having the branding element.

2. The method of claim 1, wherein said defining of an user interface further identifying one or more icons, buttons, or menues.

3. The method of claim 1, where said defining of the features comprises identifying resources of the features.

4. The method of claim 3, wherein said identifying of resources comprises identifying one or more images, HTML pages, or style sheets.

5. The method of claim 3, wherein said identifying of resources comprises identifying data items of databases on a client device consuming the branded application, to be updated.

6. The method of claim 1, wherein said associating of the plurality of features with the user interface comprises jointly expressing the user interface and the features in terms of XML statements.

7. A computer readable medium containing computer executable instructions for performing the actions of the method of any of claims 1-3 and 6.

8. An apparatus having a processor coupled to a memory containing computer executable instructions operative to perform the actions of the method of any of claims 1-3 and 6.

9. An apparatus having a processor coupled to a memory containing computer executable instructions operative to perform the actions of the method of claims 1, wherein the apparatus is a wireless mobile phone, further comprising a communication interface.

10. A method of branding a user interface of a wireless mobile device according to a predetermined appearance standard, the method comprising:
in response to a triggering event, obtaining a feature-specific data package from a remote server;
said feature-specific data package specifying a user interface branding component designed to brand a user interface formed using said user interface component in accordance with an associated feature tree; and
dynamically forming and branding the user interface of the wireless mobile device with said user interface branding component.

11. The method of claim 10 wherein said user interface branding component is selected from the group consisting of: fonts, colors, buttons, icons, images, text, sounds, and documents.

12. The method of claim 10 wherein said feature tree comprises locations of said branding component on the wireless mobile device.

13. The method of claim 10 wherein said data package specifies a location of said user interface branding component on the wireless mobile device.

14. The method of claim 10 wherein said data package includes said user interface branding component.

15. The method of claim 14 further comprising storing said user interface branding component on the wireless mobile device.

16. The method of claim 10 further comprising rendering a plurality of preexisting user interface branding components on the wireless mobile device.

17. A computer readable medium containing computer executable instructions for performing the actions of the method of any of claims 10-16.

18. A computer system having a processor coupled to a memory containing computer executable instructions operative to perform the actions of the method of any of claims 10-16.
